(19) United States
(12) Patent Application Publication
(10) Pub. No.: US 2004/0059632 A1
(43) Pub. Date: Mar. 25, 2004

(54) Method and system for providing an advertisement based on an URL and/or a search keyword entered by a user

(75) Inventors: Sang Chul Kang, SeongNam-si (KR); Chang Woo Min, Seoul (KR)

Correspondence Address: HOFFMAN WARNICK & D'ALESSANDRO, LLC, 3 E-COMM SQUARE, ALBANY, NY, 12207

(73) Assignee: International Business Machines Corporation, Armonk, NY

(21) Appl. No.: 10/667,732

(22) Filed: Sep. 22, 2003

(30) Foreign Application Priority Data
Sep. 23, 2002 (KR) 10-2002-0057523

(51) Int. Cl. G06F 17/60

(52) U.S. Cl. 705/14

(57) ABSTRACT

Method and apparatus for providing an advertisement to a user over the Internet, based on an URL and/or a search keyword that the user entered. The method includes the steps of obtaining from a first server a plurality of web page URLs and search keywords and associated advertisement information for each of the web page URLs and the search keywords, the advertisement information including an address at which associated advertisement data is stored, and storing the advertisement information in a local storage; detecting an URL and a search keyword that the user enters on a web browser; retrieving from the local storage the advertisement information associated with the detected URL and the search keyword; reading from a second server the associated advertisement data at the advertisement address included in the retrieved advertisement information; and displaying the advertisement.

### BACKGROUND OF THE INVENTION

1. Technical Field

This invention relates to a method, apparatus and computer program product for providing an advertisement over the Internet, based on an URL and/or a search keyword input by a user.

2. Description of the Related Art

Recently, with the development of the Internet and the widespread use of computers, Internet-based advertising markets are quickly growing. Currently, the most common advertisement method through the Internet is to display an advertisement using a “banner” or a “pop-up” window contained in a certain web site, such as a portal or search site, where users are most likely to visit. However, such an advertisement method has the disadvantage that an advertisement is only seen when a user visits a web page that includes a banner or pop-up advertisement window. In this regard, co-pending U.S. patent application Ser. No. (IBM docket No. JP9-2001-0343), which is commonly assigned and is incorporated by reference herein, discloses a method for providing an advertisement window for continuously displaying an advertisement in a certain area of a web browser. The method, however, cannot provide an advertisement that may be interesting to a user, since it cannot recognize the user's preference or interest.

Therefore, it would be desirable to contemplate a mechanism that can determine a user's preference, based on an URL, a search word or the combination thereof, and then provide the associated advertisement to the user in a certain area of the screen of the user's computer, in order to increase the advertising effect.

### SUMMARY OF THE INVENTION

The present invention provides a method of providing an advertisement to a user over the Internet. According to the preferred embodiment, the method comprises obtaining from a first server a plurality of web page URLs and associated advertisement information for each of the web page URLs, said advertisement information including an address at which associated advertisement data is stored, and storing said advertisement information in a local storage; detecting an URL that the user enters on a web browser; retrieving from the local storage the advertisement information associated with the detected URL; reading from a second server the associated advertisement data at the advertisement address included in the retrieved advertisement information; and displaying the associated advertisement data in accordance with the advertisement information.

In another embodiment, the method comprises obtaining from a first server a plurality of web page URLs and search keywords and associated advertisement information for each of the web page URLs and the search keywords, said advertisement information including an address at which associated advertisement data is stored, and storing said advertisement information in a local storage; detecting an URL and a search keyword that the user enters on a web browser; retrieving from the local storage the advertisement information associated with the detected URL and the search keyword; reading from a second server the associated advertisement data at the advertisement address included in the retrieved advertisement information; and displaying the associated advertisement data in accordance with the advertisement information.

### BRIEF DESCRIPTION OF THE DRAWINGS

Embodiments of the present invention will now be described, by way of examples only, with reference to the accompanying drawings, in which:

FIG. 1 is a block diagram of an overall system implementing a preferred embodiment of the present invention;

FIG. 2 is a block diagram of an advertisement providing program executed on a user's computer in accordance with the present invention;

FIG. 3 shows a table structure of an advertisement lookup database in accordance with an embodiment of the present invention;

FIG. 4 shows a table structure of an advertisement control information database in accordance with an embodiment of the present invention;

FIG. 5 is a flow chart illustrating a method of providing am advertisement in accordance with an embodiment of the present invention;

FIG. 6a shows examples of various types of URLs, which are currently used over the Internet;

FIG. 6b shows a general structure of an URL;

FIG. 6c shows a general structure of an URL in HTTP protocol;

FIG. 7 shows an exemplary screen shot of a web site including a search box.

FIG. 8 shows an exemplary screen shot of a web browser, within which an advertisement is displayed in accordance with the present invention; and

FIG. 9 shows an exemplary screen shot of a web browser, out of which an advertisement is displayed in accordance with the present invention.

### DETAILED DESCRIPTION OF THE INVENTION

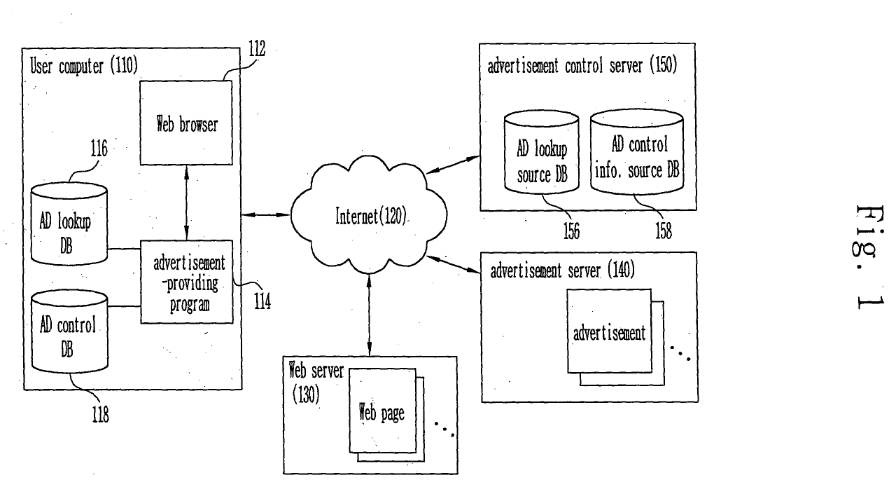

Hereinafter, features and advantages of the present invention will be explained with reference to FIGS. 1 to 9. The embodiments shown in FIGS. 1-9 are provided in order to explain the present invention and it may be variously changed. Accordingly, it should be understood that the present invention is not limited to the specific embodiments thereof.

Referring to FIG. 1, there is shown a block diagram of an overall system implementing a preferred embodiment of the present invention. As shown in FIG. 1, a user computer 110, a web server 130, an advertisement server 140 and an advertisement control server 150 are connected through the Internet 120. On the user computer 110, together with a web browser program 112 for communicating through the Internet, an advertisement-providing program 114 will be executed in accordance with the preferred embodiment of the present invention. In addition, an advertisement lookup database 116 which stores a list of advertisement information, each being associated with each URL and/or search word, and an advertisement control information database 118 which stores a list of advertisement control information including address information for each advertisement, will be in the local memory within the user computer 110.

The web browser program 112 is an application program necessary for a user to navigate web sites over the Internet. Commonly available browser programs 112 include Internet Explorer, available from Microsoft Corporation of Redmond, Wash., and Netscape Navigator, available from Netscape Corporation of Mountain View, Calif.

In preferred embodiment of the present invention, the advertisement-providing program 114 may provide a user with a proper advertisement based on the URLs and/or the search words that the user enters into the browser. Particularly, when a user enters a desired URL to access a corresponding web page through the web browser or enters a desired search word into a search box included in a web page to retrieve the corresponding results, the advertisement-providing program detects the URL and/or the search word from the user's input and provides the advertisement associated with them. Although the advertisement-providing program 114 and the web browser 112 have been shown separately, it should be apparent that the advertisement-providing program 114 may be installed as a plug-in program of the web browser 112.

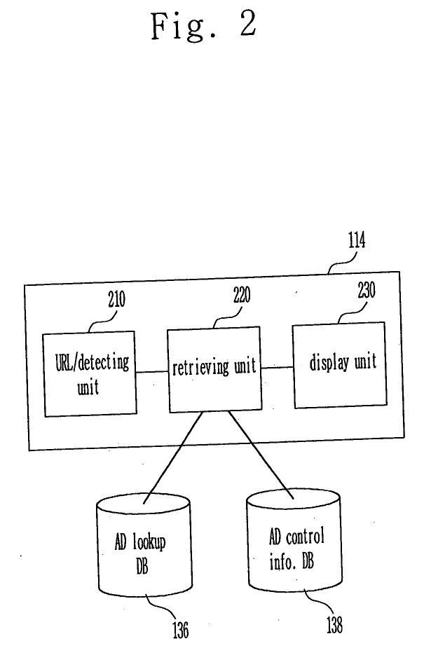

Referring to FIG. 2, there is shown a block diagram of an advertisement-providing program executed on a user computer 110 in accordance with the present invention. As shown in FIG. 2, the advertisement-providing program 114 includes a detecting unit 210, a retrieving unit 220 and a display unit 230, together with the advertisement lookup database 136 and the advertisement control information database 138 stored in a local storage. The detecting unit 210 detects the URLs and/or search words entered into the web browser by a user. The retrieving unit 220 retrieves the associated advertisement information from the advertisement lookup database 136, based on the detected URLs and/or search word, and also retrieves the advertisement control information of the associated advertisement from the advertisement control information database 138. The display unit obtains the associated advertisement data from the address specified in the retrieved advertisement control information to be displayed in a certain area of a screen, such as inside of the web browser or outside thereof. The advertisement-providing program 114 will update the advertisement lookup database 136 and the advertisement control information database 138 by periodically downloading the corresponding databases from the advertisement control server 150.

Referring back to FIG. 1, the web server 130 generally operates at least one web portal site including a plurality of web pages that the user can access by entering a certain URL address into a web browser or using a Favorites list provided by the web browser. In addition, most web portal sites provide users with a search function that enables users to search for web pages associated with a desired search word.

The advertisement server 140 refers to a particular web server that stores advertisement pages for promoting particular services or products of organizations.

The advertisement control server 150 includes an advertisement lookup source database 156 and an advertisement control information source database 158, which correspond to the advertisement lookup database 136 and the advertisement control information database 138 of the user computer 110, respectively. Those skilled in the art will easily recognize that the advertisement server 140 and the advertisement control server 150 can be implemented at the same server, although there is depicted in FIG. 1 that they have been implemented at physically separated servers.

The advertisement control server periodically updates these databases 136 and 138 by inserting, modifying and/or deleting entries in the databases using a known database management tool program. The entries of the advertisement lookup source database 156 and the advertisement control information source database 158 will be periodically downloaded to the advertisement lookup database 136 and the advertisement control information database 138, respectively, for the operation of the advertisement-providing program 114 at the user computer. In another embodiment of the present invention, the entries of the databases 156 and 158 will be downloaded to the user computer in response to a user's request.

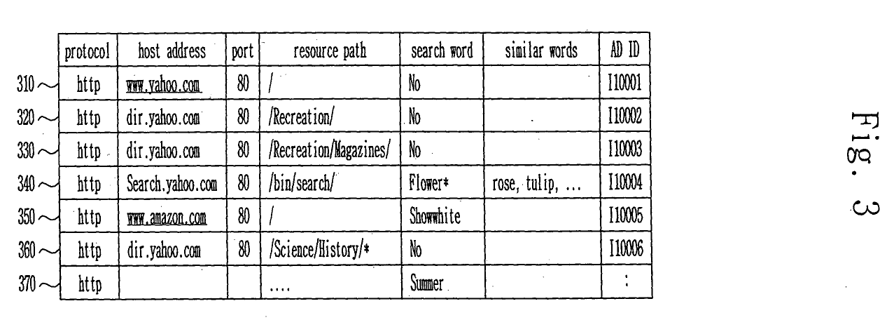

Referring to FIG. 3, there is shown a table structure of an advertisement lookup database in accordance with one embodiment of the present invention. As shown, the advertisement lookup database comprises a list of the advertisements, each being associated with an URL and/or search word. The advertisement lookup database includes information fields regarding “protocol” information, “host address,” “port,” “resource path,” “search word,” “similar search words,” and “advertisement ID.” The fields of “protocol”, “host address,” “port,” and “resource path” will be matched with the URL extracted from the user input data; the fields of the “search word” and “similar search words” will be matched with the search word(s) that the user has entered.

The “similar search words” field may include similar categories of words relating to the exact “search word.” Suppose that the “search word” is a “flower shop,” and the “similar search words” include a rose, a tulip and so on. In this case, the same advertisement will be provided to not only the users who enter a flower shop, but also to those users who enter a rose. The “advertisement ID” is the field where the identifier of an advertisement associated with a certain URL or a search word is recorded.

According to the present invention, the advertisement to be provided to a user can be selected based on the URL, a search word or a combination thereof, which have been entered by the user. Furthermore, the information contained in the fields such as the “resource path” or the “search word” can be expressed using regular expressions including “*”, “?”, and so on, in order to efficiently find an appropriate advertisement. For example, as shown in the record 360 of FIG. 3, the resource path can be expressed as “science/history/*”, which means that one more URL address containing the characters “science/history” may be associated with one advertisement (i.e., advertisement ID=I0006).

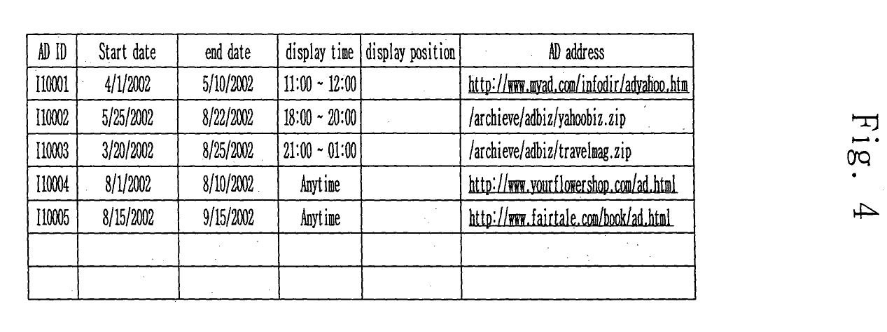

Referring to FIG. 4, there is shown a table structure of an advertisement control information database in accordance with one embodiment of the present invention. The advertisement control information database has information on the control information for each advertisement, such as “display start date”, “display end date”, “advertisement display time,” “advertisement display position,” or “advertisement address.” The information in the “display start date” and the “display end date” is used to decide the validity of the advertisement display. If the current date is not between the display start date and the display end date, the corresponding advertisement is decided to be invalid and, accordingly, it will not be displayed. The information of the “advertisement display time” is a time period during which the advertisement is displayed. By specifying the advertisement display time, different kinds of advertisements can be displayed on a time basis for the same URL and/or the search word. The information of the “advertisement display position” specifies where the advertisement will be displayed, such as within the web browser or outside of the web browser (i.e., in a certain area of a user screen). In addition, it may include the specific information on the specific location (for example, top/bottom/left/right of the screen) and size of the advertisement. The “advertisement address” may indicate the advertisement URL. It should be understood that any addition to or change of the advertisement control information is within the spirit and the scope of the present invention.

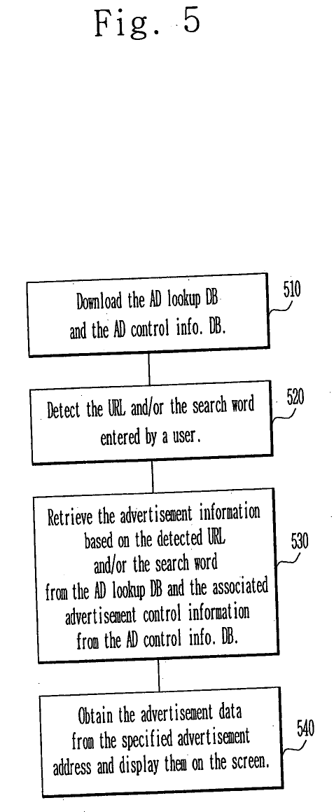

Referring to FIG. 5, there is shown a flow chart illustrating a method of providing am advertisement in accordance with an embodiment of the present invention.

First, in step 510, the advertisement lookup source database and the advertisement control information source database will be downloaded from the advertisement control server to the user computer and stored in the local advertisement lookup database and the local advertisement control database. In one embodiment, since the information stored in those databases can be periodically updated in the server, it also needs to periodically download those databases into the user computer. Alternatively, when the advertisement information corresponding to the URL and/or the search word entered by a user is not found in the local databases or when the advertisement information stored in the local databases is found to be invalid, the user computer can request the corresponding advertisement information from the advertisement server.

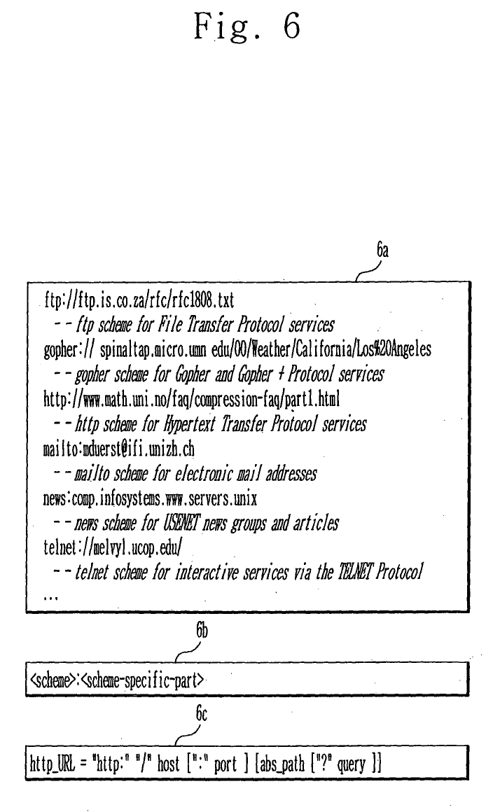

In step 520, an URL and/or a search word that is entered into the web browser by a user will be extracted. As shown in FIG. 6a, there exist many types of URLs and it is not limited thereto. FIG. 6b shows a general format of an URL, which is comprised of a scheme part defining a protocol type and a scheme-specific part specifying a certain resource connected to the Internet. FIG. 6c shows a structure of HTTP protocol-type URL, which includes a host address, a port number, resource path and (optionally) query streams.

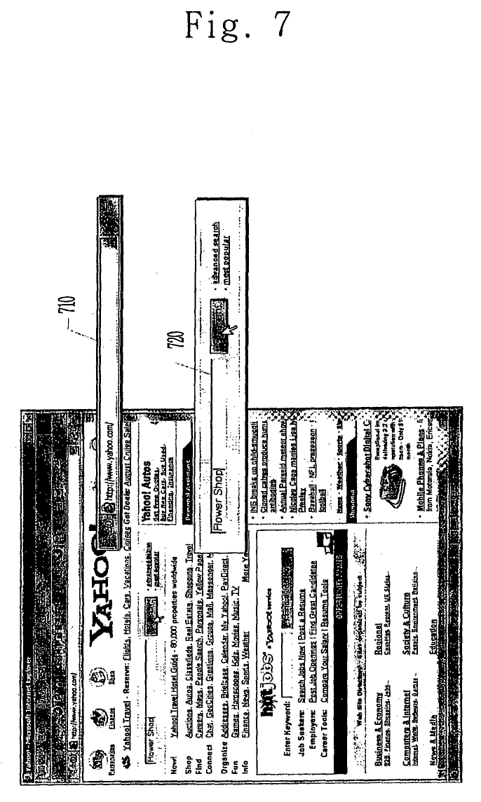

FIG. 7 shows an exemplary screen shot of a web site including a search box. As shown in FIG. 7, for example, a user can enter an URL associated with a web site to visit, such as “http://www.yahoo.com” into the address line 710 in the browser and then enter search words “flower shop” into the search box 720. The advertisement-providing program will extract the URL and search words that have been entered by the user.

Referring back to FIG. 5, in step 530, an advertisement to be provided to the user will be retrieved from the advertisement lookup database, based on the extracted URL and/or search words. The extracted URL will be divided into the information on protocol type, host address, resource path and so on, by a delimiter “/.” By comparing the extracted URL and/or search word(s) with the data stored in the advertisement lookup database, the advertisement-providing program will select the most-matched advertisement. After the most-matched advertisement is selected, the corresponding advertisement control information will be retrieved from the advertisement control information database using the identifier of the most-matched advertisement. The advertisement control information includes the information on the advertisement address at which the advertisement content data has been stored, together with the display start date and end date for a validity check, the display location and so on.

In step 540, the most-matched advertisement will be displayed on a screen of the user computer, based on the advertisement control information. The validity of the advertisement will be first checked using the information on the display start date and display end date and then the advertisement content data will be obtained from the specified advertisement address for display. The advertisement can be displayed within or outside of the web browser, based on the specified display location.

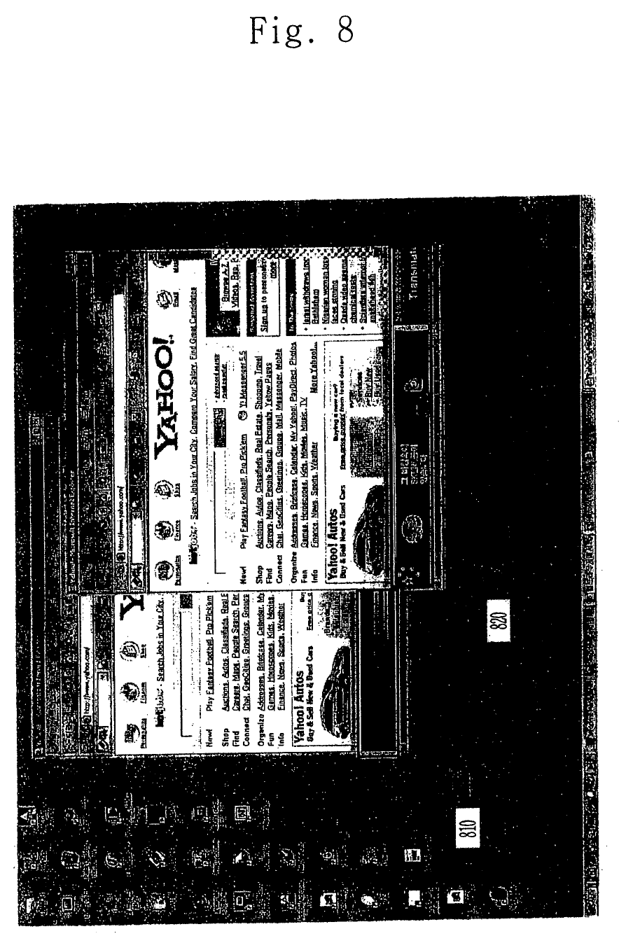

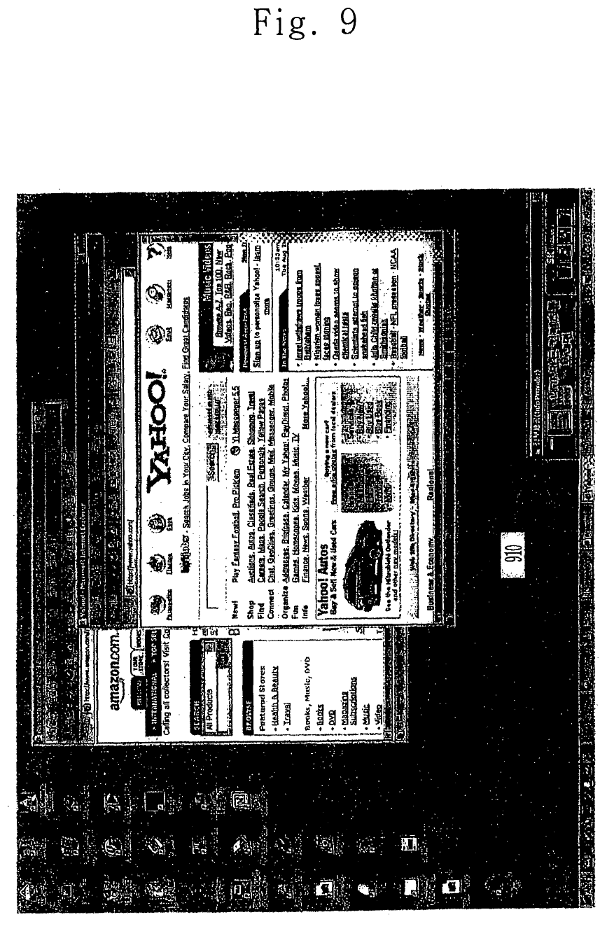

FIG. 8 shows an exemplary screen shot of a web browser, within which an advertisement is displayed in accordance with the present invention, and FIG. 9 shows an exemplary screen shot of a web browser, out of which an advertisement is displayed in accordance with the present invention.

Those of ordinary skill in the art will appreciate that the processes of the present invention are capable of being distributed in the form of a computer readable medium of instructions and that the present invention applies equally regardless of the particular type of signal bearing media actually used to carry out the distribution. Examples of computer readable media include recordable-type such as a floppy disc, a hard disk drive, a RAM and CD-ROMS and transmission-type such as digital and analog communication links.

The description of the present invention has been presented for purposes of illustration and description, but is not intended to be limited to the invention in the form disclosed. Many modification and variation will be apparent to those of ordinary skill in the art. Although the browser has been illustrated in the form of Microsoft Internet Explorer, it could be applied to other applications for sending requests and retrieving documents from the Internet or any similar distributed data processing system such as a local area network or Intranet. Accordingly, all such modification is intended to be included within the scope of this invention as defined in the appended claims.

What is claimed:

1. A method of providing an advertisement to a user over the Internet, comprising the steps of:
obtaining from a first server a plurality of web page URLs and associated advertisement information for each of the web page URLS, said advertisement information including an address at which associated advertisement data is stored, and storing said advertisement information in a local storage;
detecting an URL that the user enters on a web browser;
retrieving from the local storage the advertisement information associated with the detected URL;
reading from a second server the associated advertisement data at the advertisement address included in the retrieved advertisement information; and
displaying the associated advertisement data in accordance with the advertisement information.

2. A method of providing an advertisement to a user over the Internet, comprising the steps of:
obtaining from a first server a plurality of web page URLs and search keywords and associated advertisement information for each of the web page URLs and the search keywords, said advertisement information including an address at which associated advertisement data is stored, and storing said advertisement information in a local storage;
detecting an URL and a search keyword that the user enters on a web browser;
retrieving from the local storage the advertisement information associated with the detected URL and the search keyword;
reading from a second server the associated advertisement data at the advertisement address included in the retrieved advertisement information; and
displaying the associated advertisement data in accordance with the advertisement information.

3. The method of claim 1, wherein said step of storing comprises the step of representing the web page URLs using regular expressions.

4. The method of claim 2, wherein said step of storing comprises the step of representing the web page URLs and the search keywords using regular expressions.

5. The method of claim 1, wherein the advertisement information includes information on an effective display period of time and display location information of the advertisement.

6. The method of claim 5, wherein said step of displaying further comprises the step of determining if the effective display period of time for the advertisement to be displayed has expired.

7. The method of claim 5, wherein said step of displaying further comprises the step of determining if the advertisement will be displayed within a web browser or outside the web browser, based on the display location information.

8. The method of claim 1, wherein the first server and the second server are the same server.

9. System for providing an advertisement to a user over the Internet, having a computer including a CPU and a memory, comprising:
a storing operation unit which operates the CPU to obtain from a first server a plurality of web page URLs and associated advertisement information for each of the web page URLs, said advertisement information including an address at which associated advertisement data is stored, and to store said advertisement information in the memory;
a detecting operation unit which operates the CPU to detect an URL that the user enters on a web browser;
a retrieving operation unit which operates the CPU to retrieve the advertisement information associated with the detected URL from the memory; and
a displaying operation unit which operates the CPU to read from a second server the associated advertisement data at the advertisement address included in the retrieved advertisement information and to display the advertisement.

10. System for providing an advertisement to a user over the Internet, having a computer including a CPU and a memory, comprising:
a storing operation unit which operates the CPU to obtain from a first server a plurality of web page URLs and search keywords and associated advertisement information for each of the web page URLs and the search keywords, said advertisement information including an address at which associated advertisement data is stored, and to store said advertisement information in the memory;
a detecting operation unit which operates the CPU to detect an URL and a search keyword that the user enters on a web browser;
a retrieving operation unit which operates the CPU to retrieve the advertisement information associated with the detected URL and the search keyword from the memory; and
a displaying operation unit which operates the CPU to read from a second server the associated advertisement data at the advertisement address included in the retrieved advertisement information and to display them

11. The system of claim 9, wherein the web page URLs are represented by regular expressions.

12. The system of claim 10, wherein the web page URLs and the search keywords are represented by regular expressions.

13. The system of claim 9, wherein the advertisement information includes information on an effective display period of time and display location of the advertisement.

14. The system of claim 13, wherein said displaying operation unit further comprises a determining operation unit which operates the CPU to determine if the effective display period of time for the advertisement to be displayed has expired.

15. The system of claim 13, wherein said displaying operation unit further comprises a location-determining operation unit which operates the CPU to determine if the advertisement will be displayed within a web browser or outside the web browser, based on the display location information.

16. The system of claim 9, wherein the first server and the second server are the same server.

17. A computer-readable medium having stored thereon program instructions executable by a computer to perform a method of providing an advertisement to a user over the Internet, the method comprising the steps of:
obtaining from a first server a plurality of web page URLs and associated advertisement information for each of the web page URLs, said advertisement information including an address at which associated advertisement data is stored, and storing said advertisement information in a local storage;
detecting an URL that the user enters on a web browser;
retrieving from the local storage the advertisement information associated with the detected URL;
reading from a second server the associated advertisement data at the advertisement address included in the retrieved advertisement information; and
displaying the associated advertisement data in accordance with the advertisement information.

18. A computer-readable medium having stored thereon program instructions executable by a computer to perform a method of providing an advertisement to a user over the Internet, the method comprising the steps of:
obtaining from a first server a plurality of web page URLs and search keywords and associated advertisement information for each of the web page URLs and the search keywords, said advertisement information including an address at which associated advertisement data is stored, and storing said advertisement information in a local storage;
detecting an URL and a search keyword that the user enters on a web browser;
retrieving from the local storage the advertisement information associated with the detected URL and the search keyword;
reading from a second server the associated advertisement data at the advertisement address included in the retrieved advertisement information; and
displaying the associated advertisement data in accordance with the advertisement information.
